(19) United States
(12) Patent Application Publication
(10) Pub. No.: US 2025/0033508 A1
(43) Pub. Date: Jan. 30, 2025

(54) Monitored Charging Method Considering Charging Station Surge Protection Measures

(71) Applicant: Vitesco Technologies Germany GmbH, Regensburg (DE)

(72) Inventors: Franz Pfeilschifter, Walderbach (DE); Martin Götzenberger, Ingolstadt (DE)

(73) Assignee: Vitesco Technologies Germany GmbH, Regensberg (DE)

(21) Appl. No.: 18/771,184

(22) Filed: Jul. 12, 2024

Related U.S. Application Data
(63) Continuation of application No. PCT/EP2023/051233, filed on Jan. 19, 2023.

(30) Foreign Application Priority Data
Jan. 27, 2022 (DE) 10 2022 200 915.0

(51) Int. Cl. B60L 53/63; H02H 9/04

(52) U.S. Cl. CPC B60L 53/63; H02H 9/04; B60L 2210/10

(57) ABSTRACT

A monitored DC charging method for charging a vehicle rechargeable traction battery by way of a charging voltage source external to the vehicle is provided. The rechargeable traction battery has a nominal voltage of at least 500 V. In a checking step, the method includes detecting whether the charging voltage source has a surge protector which includes a voltage limiting element that is provided between a charging voltage potential and a ground potential of the charging voltage source and is set up to transition to a conductive state from a voltage below the nominal voltage. DC voltage is transmitted from the charging voltage to the rechargeable traction battery when the charging voltage source does not have the surge protector. At least one DC charging mode for transmitting DC voltage from the charging voltage source to the rechargeable traction battery is suppressed when the charging voltage source has the surge protector.

### CROSS-REFERENCE TO RELATED APPLICATIONS

This application claims the benefit of PCT Application PCT/EP2023/051233, filed Jan. 19, 2023, which claims priority to German Application 10 2022 200 915.0, filed Jan. 27, 2022. The disclosures of the above applications are incorporated herein by reference.

### TECHNICAL FIELD

The disclosure relates to a monitored charging method that considers charging station surge protection measures.

### BACKGROUND

Equipping vehicles with an electric drive is known practice. In order to charge the vehicle storage device in the form of a rechargeable battery, charging stations are provided, which are connected to the vehicle via a cable.

Due to the high required charging power or traction power, the electric drive and the rechargeable battery are designed for nominal voltages in the high-voltage range, that is to say for voltages far above 60 V. In addition to 400 V systems for vehicles, 800 V systems for vehicles now also exist. Furthermore, corresponding charging stations exist, which are designed in compliance with charging standards. One of these standards is the CHAdeMO standard, where versions of this standard provide charging voltages of up to 500 V DC voltage.

Since 800 V vehicle rechargeable batteries are now used in many vehicles, but the charging voltage may differ from that depending on the standard, for example a DC voltage of 500 V maximum as charging voltage, to the disclosure provides an option by way of which safe charging operation is possible in spite of the different charging voltage.

### SUMMARY

In charging standards such as the CHAdeMO charging standard, charging standard safety measures are provided, which can become problematic if a charging station outputs a first DC voltage for charging in order to charge a rechargeable battery having a second DC voltage, which is higher than the first DC voltage, in a vehicle, if an insulation fault of a high-voltage potential (of the second DC voltage) occurs with respect to ground. This results, in particular, from CHAdeMO charging stations according to the standards 1.0 and 2.0 having surge protection elements in the form of varistors, by way of which the high-voltage potentials with respect to ground are protected. These varistors begin to conduct in the event of a threshold voltage or in the event of a voltage value which is above the maximum charging voltage, for example if too high a voltage with respect to ground occurs owing to a fault or a lightning strike.

However, when charging a rechargeable battery having a nominal voltage greater than the maximum charging voltage (such as, greater than the threshold voltage or than the voltage value), these safety measures mean that, for example, in the case of an insulation fault of a high-voltage potential with respect to ground on one side, the other high-voltage potential with respect to ground has a voltage of a type which leads to the surge protection elements beginning to conduct. This leads to an undesirable high current flow. In other words, in the high-voltage section, which carries the second DC voltage, in the event of an insulation fault with respect to ground on one side, a strong asymmetry of the potentials of the second DC voltage with respect to ground is created, as a result of which such a high voltage with respect to ground can be created on one side that the surge protector of the charging station becomes active (conductive).

Actually, this is the case if, in the case of an exemplary DC voltage system which has a voltage of +400 V or −400 V with respect to ground in the fault-free state, the voltage of 0 V or 800 V with respect to ground is present in the event of an insulation fault on one side, so that this high voltage of 800 V leads to the surge protector being tripped.

The activation of the surge protector leads to a high ground current, wherein, owing to the low internal resistance of the rechargeable battery, this ground current may be so high that it is not guaranteed that the grounding remains intact. This is the case in particular for charging stations having a grounding cable which has a relatively small cross section (compared to the cross section of the high-voltage lines of the charging station). If the grounding is therefore damaged due to the high current flow due to the asymmetric shift (as a result of an insulation fault with respect to ground), for example, in the case of small grounding cross sections, then the vehicle in which an insulation fault is present remains without a grounding potential terminal, as a result of which dangerously high contact potentials at the chassis of the vehicle cannot be excluded and as a result of which fault detection may be defective.

Therefore, it is proposed for a rechargeable traction battery with a nominal voltage which is greater than the voltage (threshold voltage) at which a voltage limiting element of the charging station begins to conduct—that is to say for a rechargeable traction battery having such a high voltage that, in the event of an insulation fault of a high-voltage potential with respect to ground on one side, the surge protector of the charging station takes effect (and thus may trigger further dangers)—first to check whether the charging station has a surge protector which could become conductive. If this is the case, then at least one DC charging mode is actively suppressed. If it is detected that the charging station does not have the surge protector (as a result of which the aforementioned problem does not exist), then this DC charging mode, which would otherwise be suppressed, is permitted and DC voltage is transmitted in accordance with this DC charging mode. The checking step provides for whether the charging voltage source has a surge protector which includes a voltage limiting element that is provided between a charging voltage potential and a ground potential of the charging voltage source and is set up to transition to a conductive state from a voltage (threshold voltage) below the nominal voltage. This is also termed critical surge protection, particularly as this becomes active if a grounding insulation fault occurs in a connected vehicle having an on-board electrical system which has a nominal voltage that is greater than a trip voltage of the surge protector.

If the nominal voltage of the rechargeable traction battery is smaller than the maximum charging voltage or smaller than the threshold voltage from which a surge protector becomes active, then the checking step can be stepped over, because the above-mentioned fault cannot occur independently of the existence of a charging station surge protector. Even in the case of an insulation fault on one side, it is not possible for the vehicle to apply a voltage at the charging station which trips the surge protector (that is to say sets the voltage limiting element to the active state), as the voltage is too low for this.

The checking step therefore detects whether a voltage limiting element is provided at the charging station, which voltage limiting element could become conductive if a corresponding voltage (that is to say a voltage of a high-voltage potential with respect to ground) arises at the charging station due to a vehicle insulation fault. As a charging standard, such as the CHAdeMO charging standard for example, defines corresponding voltage limiting elements, it is therefore possible during the check, to focus only on the standard that the charging station is designed in compliance with, in order to conclude from this whether a critical voltage limiting element is present. If this is the case, it is possible to provide for suppressing the at least one DC charging mode. This DC charging mode is a direct charging mode which can be used, for example, if a battery is severely discharged and the maximum charging voltage is suitable for charging the rechargeable battery. In addition, the DC charging mode may also be a mode in which a galvanically non-isolating converter is used in order to transmit the charging power from the charging station to the rechargeable battery in the vehicle.

In some implementations, the transmission of the DC voltage is terminated in that the fuse, such as the pyrofuse or the disconnecting switch, is tripped if the comparison shows that the deviation is greater than the predetermined tolerance value, provided that this deviation is present for a predetermined time period. The pyrofuse is to be interpreted as a switch here, as the pyrofuse can be opened like a switch by way of signal activation. In some examples, the termination is carried out provided that the comparison shows that the deviation is greater than the predetermined tolerance value and after this comparison a further comparison step is carried out (to check plausibility). This step shows that the deviation is greater than the predetermined tolerance value even after the predetermined time period has elapsed. In other words, the transmission of the DC voltage is only terminated, in that the fuse, the pyrofuse or the disconnecting switch is tripped, if even after a debouncing time period (corresponding to the predetermined time period), the comparison shows that the deviation is greater than the predetermined tolerance value. It may be provided that only the charging circuit is switched off or a reclosable switch is opened if the comparison shows that the deviation is greater than a predetermined fault limit, but the pyrofuse is not tripped immediately when this fault limit is reached.

At least one disconnecting switch or one pyrofuse may be tripped only if not only the fault limit, but also the tolerance value (greater than the fault limit) of the deviation is exceeded, for example, for the predetermined debouncing time period. Pyrofuses are therefore only tripped if a tolerance value (and not just a smaller fault limit) is exceeded. The fault limit indicates when a fault is detected which will lead to the mentioned activation of the surge protector and the tolerance value indicates when, beyond that, an actual danger for the user also exists (due to a possible contact current which is above an acceptance level, i.e., which may be dangerous for a human).

Furthermore, a vehicle charging circuit is described, which is set up to perform the method described here. The charging circuit has a DC charging connection with two contacts which have a different polarity. The first contact is connected to a linking point via a fuse. The fuse here is an overcurrent protection device or a fuse or can be designed as a pyrofuse. The first contact is connected to a linking point via this fuse. At the linking point, a first, direct, converter-free charging path is connected. This charging path has a switch, via which the linking point is connected to a first battery terminal of the charging circuit. If the switch is open, then no current can flow in the first battery path. At the linking point, a second charging path is connected. This charging path has a voltage converter. The second charging path is therefore set up to transmit power via the voltage converter in a voltage-converting manner. The linking point is connected to a second battery terminal of the charging circuit via the second charging path.

In some implementations, as noted previously in the context of the method, the voltage converter has at least one switch of an inverter as working switch and at least one winding as working inductance. This is part of an electrical machine which is activated by the inverter. As a result, the inverter and the electrical machine can be used for two functions, namely for driving or for recuperation on the one hand and for converting voltage on the other hand. A corresponding control device can be provided, which is connected to the inverter in an activating manner in order to optionally perform one of the two aforementioned functions.

The second contact of the DC voltage terminal may be connected via a diode to a second battery terminal of the charging circuit. The forward direction of the diode is provided to enable a current flow from the second battery terminal to the second contact. If the second contact is the negative polarity and the first contact is the positive polarity of the DC charging connection, then the forward direction of the diode faces toward the DC charging connection. In other words, the reverse direction of the diode faces away from the DC voltage the DC charging connection. If the positive polarity is assigned to the second contact, then the forward direction of the diode faces away from the second contact or from the DC charging connection and the reverse direction faces toward the DC charging connection.

Furthermore, the vehicle charging circuit may have a control device which is connected to the switch in an activating manner. The control device is further connected in an activating manner to at least one switch, via which at least one of the two battery terminals is connected. If the battery terminals are in each case connected via a switch (to the remaining circuit), then both battery terminals are in each case connected via a switch to the remaining circuit. Here, a switch can be provided between a first battery terminal and a point at which the two charging paths meet again. A further switch can be provided between the second battery terminal and the diode. The control device can further be connected in an activating manner to the voltage converter. The control device may be designed to carry out the checking step and to activate the switches and the DC-to-DC voltage converter optionally to transmit or to suppress transmission, depending on the result of the checking step. The control device is therefore designed to realize at least two states by way of the switches and the DC-to-DC voltage converter, namely the transmission as first state and the suppression of the transmission as the second state.

The charging voltage source used can be a charging station which is permanently installed and which is connected to a supply system. Furthermore, the charging voltage source used can also be a further vehicle, which is used for charging the rechargeable traction battery described here.

In some examples, the checking step provides for a signal to be received, which reflects whether the aforementioned surge protector (which becomes active or conductive with respect to ground below 500 V) is present at the charging voltage source or not. As this is linked to the charging standard with which the design of the charging voltage source complies, the signal can reflect the charging standard with which the design of the charging voltage source complies. From this, it is possible to conclude whether the charging voltage source has the aforementioned surge protector or not. For examples, the signal can identify whether the charging voltage source is designed in compliance with a CHAdeMO standard 2.0 or below, or not. Here, “CHAdeMO standard 2.0 or below” designates a CHAdeMO standard which provides that a surge protector (relating to the voltage between a charging voltage potential and ground) is present on the charging voltage source side, which becomes active from a voltage (threshold voltage) of approximately 500 V, such as a voltage (threshold voltage) of less than 800 V, 700 V or 600 V. Becoming active here means that the surge protector becomes active when the relevant voltage (threshold voltage) is reached and provides a conductive path between a high-voltage potential and ground. On the vehicle electrical system side, a control device or a different device can be provided in this case, which is set up to receive and accordingly to evaluate a corresponding signal.

When a signal is received which identifies a CHAdeMO standard 2.0 or below, the at least one DC voltage mode is suppressed. When a signal is received which identifies a CHAdeMO standard above that or in general identifies a charging standard which does not provide the aforementioned surge protector, DC voltage is transmitted in the aforementioned DC voltage mode from the charging voltage source to the rechargeable traction battery.

To receive a signal of this type, the charging circuit can have a signal receiver. This signal receiver is set up (for example, by implementing a corresponding data transmission protocol) to receive the signal which identifies the standard with which the design of the charging station complies. A control unit can be provided to receive this signal from the signal receiver and to evaluate whether the signal identifies a charging standard which provides a surge protector having a voltage limiting element for the charging station. The signal receiver can be wireless or wired. The signal receiver and the control unit can be designed as a common device.

In addition to the possibility of focusing on the charging standard to determine whether a surge protector with voltage limiting element is present, i.e. based on an information signal that is transmitted from the charging station to the vehicle charging circuit, it is also possible, by way of a test signal, to determine whether a surge protector with voltage limiting element is present or not. The test signal can be designed to trip a voltage limiting element (i.e., set it to a conductive state) in order to determine, on the basis of a corresponding signal response to the test signal, whether a surge protector with voltage limiting element is present or not. The test signal can further be designed as a signal for active measurement of the impedance of the charging voltage source, in order to determine the impedance on the basis of a corresponding signal response to the test signal, in order to determine from the impedance whether a surge protector with voltage limiting element is present or not. Examples therefore exist, which provide for determining a property of the voltage limiting element in order to conclude that a voltage limiting element is present if the property is determined and, in the case of a determination result which identifies that the property is not present, to conclude that a voltage limiting element is not present. The suitable property of the voltage limiting element here is the property to conduct from the threshold voltage and the property of having an impedance within an impedance interval typical for the voltage limiting element, such as a capacitance within a typical capacitance interval. It is also possible to determine a different electrical property which is specific for the voltage limiting element. If the property is present, then it is concluded that a voltage limiting element is present. If the determination shows that the property is not present, then it is concluded that no (potentially critical) voltage limiting element is present in the charging station.

Whether the charging voltage source has the surge protector or not me be detected in the checking step. This is detected or determined in that a test signal is applied to the charging voltage potential and the ground potential (i.e., where the voltage limiting element is connected, if it is present). A resulting signal response is detected, i.e., a signal response which results from the test signal. Whether the charging voltage source has the surge protector or not is determined on the basis of the signal response. In other words, it is proposed to detect the typical electrical property for the voltage limiting element or to determine the typical electrical property by applying the test signal and by detecting the associated signal response. The property results from the evaluation of how the signal response relates to the test signal or whether a signal response results or not. The test signal applied can be a test voltage which is above the threshold voltage. The resulting signal response is detected as a current flow (above a predetermined current threshold). The current flow is here the result of the test voltage which is applied at the voltage limiting element which is in turn set to the conductive state. Here, the polarity of the test voltage and the charging voltage potentials is taken into account; for example, the magnitude of the test voltage applied lies above the magnitude of the threshold voltage. As a result, the property of the voltage limiting element (if it is present)—to conduct if a voltage above the current threshold is applied to this element—is detected. The test voltage can originate from the rechargeable traction battery or a DC-to-DC voltage converter connected thereto; the test signal generator can be connected to the same.

Furthermore, the test signal applied, can be an excitation signal for impedance measurement. A suitable excitation signal is an AC voltage signal (or alternating current signal) having a frequency component, having several frequency components simultaneously (for example noise) or having a frequency component, the frequency of which changes over time (“sweeping”). The resulting signal response is detected as a signal which identifies an impedance of the charging voltage source, particularly while taking the test signal into account. In the case of an AC voltage signal as excitation signal, the signal response can be detected as a current signal. In the case of an alternating current signal as excitation signal, the signal response can be detected as a voltage signal.

In some examples, the test voltage is applied with current limiting, so that only a limited current flows when the voltage limiting element is conductive. The current limiting of the test signal can be provided in a simple manner by way of a switchable series resistor (current limiting resistor connected in series) or else by corresponding activation of the DC-to-DC voltage converter, in order to generate a test signal with limited current intensity. The test signal can be limited to a maximum current intensity of not more than 1 A, 100 mA, 10 mA or 1 mA. The series resistor (current limiting resistor) can be provided as a switchable resistor, such as a series circuit of a resistor element and a switch. The switch may be (in the checking step) temporarily closed.

A test signal generator can be provided at the vehicle (for example in a charging circuit). This test signal generator is set up to generate the test signal. The test signal generator may be connected (at the output) to the charging voltage potential and the ground potential. This is used to apply the test signal to these potentials. The test signal generator can be connected (particularly at the input) to the rechargeable traction battery, to a DC-to-DC voltage converter connected thereto or to a low-voltage source. A detection device can further be provided, which is set up to detect the signal response generated from the test signal. The detection device can be connected at the input to the charging voltage potential and/or the ground potential, such as in a signal-transmitting manner or via a voltage divider or via a capacitive coupling. The test signal generator and the detection device together form a detection module for actively detecting or measuring an electrical property of the voltage limiting element. The control device can be connected downstream of the detection device or the detection module or can be part thereof or of a common device.

In some examples, the vehicle charging circuit, by way of which the DC voltage is transmitted, have a first, direct and converter-free path and also a second charging path. The second charging path is routed via a voltage converter. This can be formed as a dedicated voltage converter or can be formed from windings of an electrical machine as working inductance of the voltage converter and a switch of the inverter as working switch of the voltage converter, where inverter and windings belong to a vehicle drive, such as a traction drive. The windings are windings of an electrical machine of the electric drive of the vehicle, such as the stator. The method provides for a selection to be made of whether the transmission takes place via the first charging path or via the second charging path. This relates to the transmission from the charging voltage source to the rechargeable traction battery or the transmission of the DC voltage via the vehicle charging circuit. The step of selection can provide for the first or the second path being provided depending on the charging state or on the terminal voltage of the rechargeable traction battery that is to be charged. If the difference between charging voltage and rechargeable traction battery voltage is greater than a predetermined margin, then the second charging path is selected, as this charging path has the voltage converter, by way of which the voltage can be adjusted. If the difference is smaller, then the first (direct) charging path can be selected.

The voltage converter used according to the method is a DC-to-DC voltage converter, such as a step-up converter, where other converter types also come into consideration, however. The voltage converter can have at least one dedicated working switch and at least one dedicated working inductance as converter elements and be set up to effect the conversion by cycling the working switch together with the inductance. Here, working switch and working inductance only have the task of voltage conversion and are not set up for realizing functions inside a drive or inside the traction drive of the vehicle. Alternatively, to constitute the converter, particularly a working switch of the converter, a switch of an inverter is used, where one or more switches of the inverter can be used here. In addition, a winding of the electrical machine, such as the electrical machine of the traction drive, can be used as working inductance. It is possible to use both switches of the inverter as working switches and at least one winding of the electrical machine as working inductance. This allows the constitution of a converter without dedicated power elements. Particularly when using a switch of the inverter as working switch and at least one winding of the electrical machine as working inductance, it is possible to provide for the activation of the inverter also to be designed to activate the same together with the working inductance as converter. A corresponding control device or inverter control would therefore have two functions, namely the activation of the inverter to generate a rotating field in the electrical machine and the activation of at least one switch of the inverter as working switch of the voltage converter.

A further aspect of the procedure described here is insulation monitoring in which the degree of symmetry of the charging voltage potentials with respect to a ground potential is determined. The charging voltage potentials are electrically insulated with respect to the ground potential in fault-free operation. If the insulations are approximately equal, there is also a symmetry of the charging voltage potentials over the ground potential. For charging voltage potentials of + and −400 V (that is to say for a charging voltage of 800 V), the ground potential would be approximately 0 V, as the ground potential should have approximately the same insulation resistance with respect to the two charging voltage potentials. If an insulation fault of one of the charging voltage potentials develops with respect to the ground potential, then the ground potential is shifted with respect to the charging voltage potential. In particular, the voltage between the defectively insulated charging voltage potential and the ground potential is considerably smaller than in fault-free operation. Due to the insulation fault, the relevant charging voltage potential is pulled to the ground potential, so that a very low voltage arises between the same, that is to say considerably smaller than half the charging voltage, while the voltage between the insulation-fault-free charging voltage potential and the ground potential is considerably higher than half the charging voltage and in particular can be close to the total charging voltage. This high voltage between insulation-fault-free charging voltage potential and the ground potential then leads to the tripping of the surge protector on the charging voltage source side provided that the voltage (threshold voltage), at which the surge protector is activated, is smaller than the charging voltage.

This asymmetry can be detected by comparing (the magnitude of) the voltage difference of a charging voltage potential with respect to the ground potential to a predetermined rated value. If the magnitude of the voltage difference (in the positive or negative direction) deviates by more than a predetermined safety margin from the rated value, this corresponds to the detected asymmetry, as a result of which the insulation fault can be detected. For a charging voltage of for example 800 V, the rated value can therefore be 400 V (or more than half the charging voltage, for example 500 V), where there is an asymmetry if the voltage between charging voltage potential and ground potential is considerably smaller than the rated value (where the relevant charging voltage potential is then defective) or if the relevant voltage is considerably larger than the rated value, where the other charging voltage potential then has the insulation fault. Alternatively or in combination therewith, the magnitude of the voltage difference of a charging voltage potential and the ground potential can be compared to the voltage difference between the other charging voltage potential and the ground potential, in order to detect the asymmetry directly as a result. An insulation fault signal is output if the comparison shows that there is a deviation which is greater than a predetermined fault limit or safety margin. Otherwise, no insulation fault signal is output or a signal is output, which indicates that there is no insulation fault present.

Furthermore, the voltage converter may be switched off if the comparison shows that the deviation is greater than a predetermined fault limit. The voltage converter can be switched off in that the working switch thereof is set to a permanently open state. As a result, if an insulation fault is present, it is avoided that the converter still continues to operate and output converted DC voltage. This fault limit corresponds to a deviation which allows the drawing of the conclusion that a dangerously high contact voltage may be present, that is to say that a contact voltage may be present at the chassis of the vehicle, which is not permitted according to a high-voltage safety standard.

A further aspect of the disclosure provides that in the event of a detection of a small deviation, the charging or the transmission of DC voltage is continued or at least a charging mode remains permitted, and that in the event of a stronger deviation, the transmission of DC voltage is terminated or suppressed, as described previously. To distinguish this, a tolerance value is used, below which it is assumed that there is no danger and above which it is assumed that there is a possible danger. Between the tolerance value and the previously mentioned fault limit, a safety margin can be provided. If the deviation is not greater than the tolerance value, then an insulation information signal can be output, which indicates that the insulation should be checked, but includes that there is no dangerous insulation fault present. If the previously mentioned fault limit is exceeded, a fault signal is output by contrast, which indicates a critical insulation fault and which includes terminating the transmission process in the context of the charging process.

If the fault limit is exceeded or if the deviation is greater than a predetermined tolerance value, such as greater by at least a safety margin, then tripping a fuse might be available, particularly a pyrofuse. Alternatively or in combination with this, a disconnecting switch can be tripped, such as in that the disconnecting switch is opened. This disconnection is therefore only tripped if the deviation indicates a contact voltage that is actually dangerous or that a contact voltage may be applied at the chassis, which is not permitted according to a high-voltage safety standard.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is used to explain an exemplary procedure.

Like reference symbols in the various drawings indicate like elements.

### DETAILED DESCRIPTION

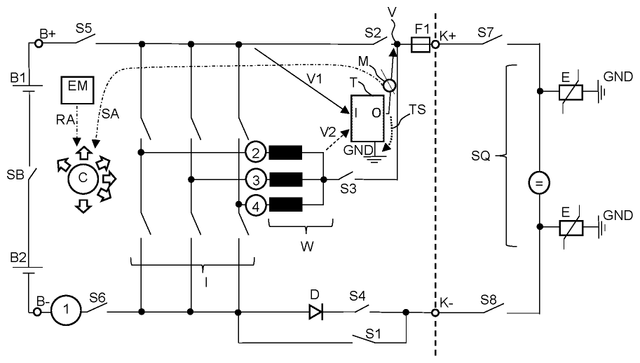

FIG. 1 shows an exemplary vehicle charging circuit. The vehicle charging circuit has battery terminals B+, B− which are connected to a battery circuit. In the illustrated example, the battery circuit includes two batteries B1, B2 (realized as a high-voltage rechargeable battery in each case) which are connected in series and which are connected to one another via a disconnector device, which is realized as a pyrofuse for example. The battery circuit can generally have two rechargeable batteries (high-voltage rechargeable batteries) which are connected in series, where a pyrofuse, generally a fuse or a disconnecting switch is likewise connected in series. The two rechargeable batteries can be connected to one another directly in series, where a disconnecting switch, a fuse or in particular a pyrofuse can then be connected (in series), so that this resulting series circuit is then connected to the battery terminals. A placement in the center between the two high-voltage rechargeable batteries is illustrated.

Connected to the battery circuit (B1, SB, B2) are a first battery terminal B+ and a second battery terminal B−. The polarity can be seen from the reference signs. Optionally, a switch S5 is connected in series to the first battery terminal B+, which switch constitutes the connection to the further charging circuit. A further optional switch S6 connects the second battery terminal B− to the remaining charging circuit. Furthermore, a current measuring device 1 can be provided between the second battery terminal B− and the switch S6. This measuring device can also be located directly downstream of the switch S6.

The illustrated switches S5 and S6 are used for controlled connection of the two battery terminals B+, B− to an inverter I which is designed as a traction inverter and which has three half bridges. Each of these half bridges has an intermediate point, The intermediate point is used as a phase connection for three windings W of an electrical machine. Three current measuring devices 2, 3, 4 are further illustrated, which are provided between the electrical machine or the windings W of the electrical machine and the phase connections of the inverter I.

The windings W are connected to one another in star point connection, where a switch S3 is connected to the star point.

The inverter I has two DC voltage terminals which are connected to the positive or the negative rail. A positive DC voltage terminal of the inverter I is connected to a potential rail which connects the switch S5 (which leads to the first battery terminal B+) to a switch S2. A second DC voltage terminal of the inverter I is connected to a potential rail (a negative potential rail) which connects the switch S6 or the second battery terminal B− to a diode D on the one hand and to a switch S1 on the other hand. The diode D is connected in series to a switch S4. A switched diode circuit having the diode D and the switch S4 is created. The switch S1 is connected in parallel to this diode circuit. The switch S1 bridges the diode circuit in the closed state. In particular, if it is determined that no critical surge protector is present at the charging station, the switch S1 can be closed. This then creates the possibility of feeding back energy from the battery terminal B+, B− to the illustrated contacts K+, K− of a DC charging connection.

On the diode circuit D, S4 side or on the switch S1 side, which faces away from the inverter or which faces away from the battery terminal B−, a second (negative) contact K− is provided. This belongs to a DC charging connection which also has a first (positive) contact K+. The first contact K+ is connected to a connecting point V via a (optional) fuse F1. The fuse S1 is realized as a supplementary fuse, but can be designed as an electronic fuse or pyrofuse.

The connecting point V, which is connected via the switch S3 to the star point of the windings W, is further connected via the switch S2 to the positive potential rail which leads to the positive battery terminal B+ or to the switch S5.

The switches S5 and S6 therefore form all-pole disconnecting switches on the charging circuit side for the controlled disconnection of the battery terminals B+, B−. The switch SB (realized as a pyrofuse in particular) is part of the battery circuit which is connected to the battery terminals. This is likewise true for the disconnection of the battery circuit or the batteries B1 and B2, so that in the open state it is not possible to apply a potential that results from the sum of the two voltages of the batteries B and B2.

From connecting point V (as seen from the first contact K+), a first direct charging path proceeds via the switch S2 (and via the optional switch S5) to the first battery terminal B+. This charging path is converter-free. From connecting point V, a second charging path leads via the (optional) switch S3, the windings W and the inverter I likewise to the battery terminals (B+). As at least one of the windings W together with at least one of the switches I or together with a half bridge of the inverter I can form a voltage converter, the second charging path has a voltage converter. A control unit Cis set up to activate the switches of the inverter I in order thus to provide the DC-to-DC voltage conversion function for the second charging path. The connecting point V is protected with respect to the first contact K+ of the DC charging connection by way of the fuse F1. Alternatively or in combination with this, this fuse can also be connected upstream of the second contact K−.

The contacts K+, K− of the DC charging connection form the opposite end of the charging circuit to the battery terminals B+, B−. Thus, B+, B− on one side and K+, K− on the other side form the two ends of the charging circuit.

It is illustrated that a voltage source SQ is connected to a charging circuit via the contacts K+, K−. This voltage source is connected via optional switching elements S7, S8, which are provided for all poles. The voltage source SQ is a charging voltage source and is formed by a DC charging station or by a vehicle which outputs charging energy. The switches S7, S8 are used for self protection of this voltage source SQ.

The control unit C is additionally connected to the switches of the charging circuit and optionally also to the disconnecting switch of the battery circuit (B1, SB, B2) in an activating manner. The control unit C is set up to detect whether the voltage source SQ has a surge protector which is designed or set up to conduct current if, at one of the contacts K+, K−, a voltage arises with respect to a ground potential, which corresponds to the sum of the nominal voltages (or minimum operating voltages) of the rechargeable batteries B1 and B2. If this is the case or if the checking step gives the result that this is true, then the control device C is set up to trip or to open at least one of the switches S1, S2, S4, S5, S6 or SB or is set up to suppress at least one DC charging mode by opening at least one of these switches. Even the switch S3 can be opened here.

Furthermore, at least one further of these switches can be opened if in addition, a current flow is determined due to the surge protector, which exceeds a (predetermined) fault limit. This identifies a current value from which the present fault is detected based on the current flow.

If one of the aforementioned switches is designed as a switch which is to be opened only once, for example as a pyrofuse, then this may only be opened if the previously mentioned conditions are fulfilled and in addition if a current flowing (through element E) due to the surge protector is determined, which exceeds a tolerance value. This tolerance value is greater than the fault limit. The tolerance value specifies the threshold from which the current flow can become dangerous for a human. The fault limit specifies the current flow from which a fault is detected, which is connected with a current flow due to the surge protector of the charging station and is lower than the tolerance value. Therefore, if the tolerance value is exceeded, a further switch can be opened, which is not opened if the fault limit is exceeded. In the event of a current between tolerance value and fault limit, a limited charging can take place, i.e., one DC charging state can be suppressed, while a different DC charging state is permitted. The two DC charging states can be distinguished by the charging path that is respectively used. The control device C is designed for this purpose.

In some implementations, the control device C is designed to activate the switches of the inverter in the open state if it is detected that the charging voltage source has a surge protector which includes a voltage limiting element E that is provided between a charging voltage potential and a ground potential GND of the charging voltage source SQ and is set up to transition to a conductive state from a voltage (threshold voltage) below the nominal voltage. The control device C can to this end have a signal input or a receiving device, by way of which information can be transmitted to the control device C, which reports whether the charging voltage source SQ has a surge protector (or is connected thereto) which includes a voltage limiting element E which is set up to transition to the conductive state in the event of a voltage (threshold voltage) below the nominal voltage. Nominal voltage here means the nominal voltage of the entire battery circuit, that is to say the sum of the nominal voltages of the rechargeable batteries B1 and B2.

The possibility of connecting a signal receiver EM to the control device Cis illustrated. The signal receiver EM is designed to receive a signal RA which corresponds to the information or which identifies whether the charging voltage source (charging station) is designed in compliance with a CHAdeMO standard 2.0 or below, or not (or which standard the charging voltage source or charging station is designed in compliance with).

Furthermore, there are further possibilities in addition to this, which aim, by way of a test signal TS, to actively determine (by excitement by way of signal TS) a property specific to the voltage limiting element E, for example the property of conducting above a threshold voltage (and not below) or the property of having a specific impedance for the element E. A test signal generator T is illustrated, which has an input I which is connected on one side to a potential of the rechargeable traction batteries B1, B2 or the battery terminals B+, B− or a (output) potential of the voltage converter I, W (charging voltage potential) and is connected on the other side to the grounding potential GND. The test signal generator T applies the test signal TS to both these potentials.

The test signal generator TG may correspond to a current limiting resistor which is connected in series, particularly between the potential corresponding to B+, B− or the (output) potential of the voltage converter and the point V. Via a connection V1 or V2, the test signal generator TG or the input I thereof can be connected to a charging voltage potential (of the rechargeable batteries or the DC-to-DC voltage converter). An output O of the test signal generator TG may be connected via a detection device M to one of the contacts K+ or K− (or to the point V). If the detection device M is an ammeter, then this can detect whether the application of the test signal leads to a (direct) current flow or not. In the first mentioned case it is assumed that a voltage limiting element E is present; in the last-mentioned case it is assumed that a voltage limiting element E is not present. In some examples, the test signal generator TG generates a voltage above the threshold voltage of the element E. A test signal generator TG can also be provided, which outputs a test signal suitable for impedance determination, where a measuring device detects the signal response. The control unit C or a different unit (T, M, . . . ) can be set up for impedance measurement and evaluation starting from the signal response (and if appropriate the test signal), in order to determine whether an impedance specific to the element E is present or not. In the first mentioned case it is assumed that a voltage limiting element E is present, in the last-mentioned case it is assumed that a voltage limiting element E is not present. In the case of a test signal suitable for impedance measurement, the test signal generator TG can be a low-voltage device (operating voltage<60 V) and can have a voltage supply input I which is designed for a supply voltage<60 V.

If it is established on the control unit side C that a voltage limiting element E or a surge protector of this type is not present in the connected charging energy source (that is to say the circuit to the right of the contacts K+, K−), then the control unit C is set up to close the switches S5, S6, S2, S7, S8, S4 and/or S1 to enable a DC charging mode. In some examples, the transmission is suppressed in that the switch S1 is opened, which switch is connected in parallel to the connected diode circuit (series circuit made up of diode D and switch S4).

In some implementations, the following method is carried out when it is detected in the checking step that the charging voltage source does not have the surge protector: checking whether an insulation fault with respect to a grounding potential is present, particularly in the charging circuit. If it is detected that only one of the two HV potentials (B+ or K+, or B− or K−) is affected by the insulation fault, then the opposite HV potential, which is not affected by the insulation fault, accepts the full HV potential with respect to ground. If a potential shift is detected, then it is assumed that there is an insulation fault. An insulation fault can also be detected by detecting a current flow (for example by way of current measuring device 1) which is above the fault limit in particular.

If an insulation fault is detected during the use of the second charging path or it is detected in general that a fault is present in the second charging path, then the converter is switched to inactive in that the control device opens all switches of the inverter or keeps the switches in the open state.

After that, it is possible to check whether a current is flowing due to the insulation fault, which is greater than a fixed limit value. The fixed limit value may be the continuous current carrying capacity of the grounding electrode conductor used. The limit value can correspond to the tolerance limit. Furthermore, the fixed limit value can correspond to a limit contact current value of a standard for high-voltage charging, for example 100 mA, 40 mA, 20 mA or 10 mA direct current. This can be carried out in particular by detecting the current that flows across one of the two battery terminals B+, B−. In particular, it is possible to detect by way of the current measuring device 1 whether the current flowing due to the insulation fault is above the fixed limit value or not.

If the fault current is not above the fixed limit value, then the switches which are closed remain in the closed state. If the limit value is exceeded, then the switches are opened. For example, if the limit value is exceeded, the switch SB of the battery circuit is activated to open, by the control unit C. If this is a pyrofuse, then this pyrofuse is therefore only triggered by the control unit C if the fault current even at the inactive DC-to-DC voltage converter I, W is greater than a fixed limit value. This limit value can correspond to the tolerance value mentioned in the introduction (or the predetermined fault limit).

Therefore, it is not in every case that, if an insulation fault is present or if a critical surge protector is present, a pyrofuse or a different switch of the illustrated circuit, which can no longer be closed, is opened, rather only if the fault current, in spite of the switched-off voltage converter, is greater than a limit value which reflects a limit from which the contact current is dangerous for humans. This can be defined by a limit value which is presented in the standard, in particular minus a safety margin.

A number of implementations have been described. Nevertheless, it will be understood that various modifications may be made without departing from the spirit and scope of the disclosure. Accordingly, other implementations are within the scope of the following claims.

What is claimed is:

1. A monitored DC charging method for charging a vehicle rechargeable traction battery by a vehicle charging circuit by way of a charging voltage source external to the vehicle, the rechargeable traction battery has a nominal voltage of at least 500 V, the method comprising:
initially in a checking step, detecting whether the charging voltage source has a surge protector which comprises a voltage limiting element that is provided between a charging voltage potential and a ground potential of the charging voltage source and is set up to transition to a conductive state from a threshold voltage below the nominal voltage;
transmitting DC voltage from the charging voltage source to the rechargeable traction battery when it is detected in the checking step that the charging voltage source does not have the surge protector; and
suppressing at least one DC charging mode for transmitting DC voltage from the charging voltage source to the rechargeable traction battery, when it is detected in the checking step that the charging voltage source has the surge protector (E).

2. The method of claim 1, wherein the checking step further comprises:
detecting whether the charging voltage source has the surge protector based on a signal received from the charging voltage source external to the vehicle, the signal identifies whether the charging voltage source is designed in compliance with a CHAdeMO standard 2.0 or below;
when the signal identifies a CHAdeMO standard 2.0 or below, suppressing at least one DC charging mode; and
when the signal identifies a CHAdeMO standard 3.0 or above or identifies a charging standard of the charging voltage source which does not provide the surge protector, transmitting DC voltage from the charging voltage source to the rechargeable traction battery.

3. The method of claim 1, wherein the checking step further comprises:
detecting whether the charging voltage source has the surge protector based on a test signal applied to the charging voltage potential and the ground potential;
detecting a resulting signal response;
determining whether the charging voltage source has the surge protector based on the signal response.

4. The method of claim 3, wherein the test signal includes a test voltage which is above the threshold voltage and the resulting signal response is detected as a current flow generated by the test voltage.

5. The method of claim 3, wherein the test signal includes an excitation signal for impedance measurement and the resulting signal response is detected as a signal which has an impedance of the charging voltage source.

6. The method of claim 1, wherein the vehicle charging circuit, by way of which the DC voltage is transmitted, has a first, direct and converter-free path and a second charging path which leads via a voltage converter, wherein the method further comprises:
selecting between the first charging path and the second charging path for transmitting the DC voltage from the charging voltage source to the rechargeable traction battery.

7. The method of claim 6, wherein when the DC voltage is transmitted via the second charging path, this DC voltage is converted by the voltage converter, wherein the voltage converter converts the DC voltage by way of a dedicated working switch and a dedicated working inductance as converter elements or converts the DC voltage by way of at least one switch of an inverter as working switch and by way of at least one winding of an electrical machine as working inductance, wherein the inverter and the electrical machine form a vehicle traction drive.

8. The monitored DC charging method of claim 1, further comprising:
before and/or during the transmission of DC voltage to the rechargeable traction battery, insulation monitoring takes place, which provides for comparing a voltage difference between a charging voltage potential and the ground potential to a predetermined nominal voltage or to a different voltage difference between a different charging voltage potential and the ground potential in order, as a result, to detect an asymmetry of the two charging voltage potentials, between which the charging voltage exists, with respect to the ground potential, wherein an insulation fault signal is output if the comparison shows that there is a deviation which is greater than a predetermined fault limit and no insulation fault signal is output if the comparison shows that the deviation is not greater than a predetermined fault limit.

9. The monitored DC charging method of claim 8, further comprising:
switching off a voltage converter of the charging when the comparison shows that the deviation is greater than a predetermined fault limit.

10. The monitored DC charging method of claim 9, further comprising:
terminating the transmission of DC voltage when, after the voltage converter is switched off, the comparison shows that the deviation is greater than a predetermined tolerance value; and
transmitting or continuing to transmit the transmission of DC voltage when, after the voltage converter is switched off, the comparison shows that the deviation is not greater than the predetermined tolerance value.

11. The monitored DC charging method of claim 10, wherein the transmission of DC voltage is terminated in that a fuse is tripped.

11x1. The monitored DC charging method of claim 11, the fuse is a pyrofuse or a disconnecting switch.

12. The monitored DC charging method of claim 11, wherein the transmission of DC voltage is terminated in that the fuse is tripped when the comparison shows that the deviation is greater than the predetermined tolerance value when after a predetermined time period after this comparison, a further comparison is carried out, which shows that the deviation is greater than the predetermined tolerance value even after the predetermined time period has elapsed.

13. A vehicle charging circuit set up for carrying out the method of claim 1, the charging circuit comprising:
a DC charging connection with two contacts of different polarity, wherein:
the first contact is connected via a fuse to a linking point, to which a first, direct, converter-free charging path is connected, which has a switch, via which the linking point is connected to a first battery terminal of the charging circuit, wherein a second charging path is connected to the linking point, which has a voltage converter, via which the linking point is connected to a second battery terminal of the charging circuit,
the second contact of the DC charging connection is connected via a diode to a second battery terminal of the charging circuit, a forward direction of the diode is provided to enable a current flow from the second battery terminal to the second contact, and
the vehicle charging circuit includes a control device which is connected in an activating manner to the switch, to at least one switch, via which at least one of the battery terminals is connected, and to the voltage converter, and is set up to carry out the checking step and to activate the switches and a DC-to-DC voltage converter to transmit or to suppress transmission, depending on a result of the checking step.

14. The vehicle charging circuit of claim 13, further comprising:
a signal receiver for receiving a signal which identifies whether the charging voltage source is designed in compliance with a CHAdeMO standard 2.0 or below;
a test signal generator generating a test signal, the test signal generator is connected to the charging voltage potential and the ground potential to apply the test signal to these potentials, and also has a detection device to detect a signal response generated from the test signal.
